(19) United States
(12) Patent Application Publication
(10) Pub. No.: US 2025/0371338 A1
(43) Pub. Date: Dec. 4, 2025

(54) ACCURATE AND SCALABLE APPROXIMATE NEAREST NEIGHBOR SEARCH (ANNS)-BASED TRAINING OF EXTREME CLASSIFIERS

(71) Applicant: Microsoft Technology Licensing, LLC, Redmond, WA (US)

(72) Inventors: Sonu MEHTA, Bengaluru (IN); Ramachandran RAMJEE, Bangalore (IN); Manik VARMA, New Delhi (IN); Nagarajan NATARAJAN, Bengaluru (IN); Jayashree MOHAN, Bengaluru (IN)

(73) Assignee: Microsoft Technology Licensing, LLC, Redmond, WA (US)

(21) Appl. No.: 18/733,403

(22) Filed: Jun. 4, 2024

(51) Int. Cl. G06N 3/08

(52) U.S. Cl. CPC G06N 3/08

(57) ABSTRACT

An extreme classification method includes receiving training data-points and classifier vectors associated with the training data-points. A plurality of training epochs are performed wherein each training epoch includes generating query embeddings for each data-point, sampling a predetermined number of negative labels from a set of negative labels for each of the training data-points; and training an encoder and the classifier vectors using the sampled negative labels. Positive labels and the sampled negative labels are then used to compute a loss. Encoder parameters and the classifier vectors are then updated based on the computed loss. For a first portion of epochs, the sampled negative labels include only uniformly random negative labels. For a second portion of the epochs, the sampled negative labels include uniformly random negative labels and hard negative labels. The hard negative labels are identified using an Approximate Nearest Neighbor Search (ANNS) index (308) built on the classifier vectors.

### BACKGROUND

Extreme classification is a subfield of machine learning focused on solving classification problems involving a very large number of labels. Traditional classification tasks might involve tens or hundreds of labels, but extreme classification deals with tasks where the number of labels can be in the thousands, millions, or even more. One of the main challenges in implementing extreme classifiers is coming up with training algorithms that are accurate and scalable to large label sets. e.g., 100 M.

Recently proposed XC training algorithms, such as Renée, achieve state-of-the-art accuracy on standard XC datasets by jointly training the classifiers and the encoder, leveraging multiple optimizations to alleviate both memory and compute bottlenecks, and using a hybrid data model parallel training pipeline. However, the per-epoch time of these algorithms scales as O(L), which implies slow convergence on larger label sets (e.g., >10 M). Another approach that has been utilized in training extreme classifiers is a modular approach where the encoder is learned first during a first stage. The classifiers are then learned in a second stage using fixed query embeddings. The staged approach relies on expensive negative sampling techniques, such as periodic clustering all the query embeddings, to keep the per-epoch costs to O(log L). The staged training approach therefore can mitigate the scaling challenge to some extent. However, the clustering procedure involves all N queries and becomes very expensive as N can even be larger than L for larger datasets.

Hence, what is needed is a method of training extreme classifiers that is capable of achieving state-of-the-art accuracy and that keeps per-epoch training costs low (e.g., O(log L)) so that the training can be scaled to extremely large label sets (e.g., 100 million or more).

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The function may include receiving a plurality of training data-points and a plurality of classifier vectors associated with the training data-points for an extreme classifier model, the training data-points each corresponding to a query, each of the classifier vectors mapping a different label of a plurality of labels associated with the extreme classifier model to an embedding space; performing a plurality of training epochs, each of the training epochs including: generating query embeddings for each of the training data-points that map the training data-points to the embedding space, the query embeddings being generated using an encoder for the extreme classifier model; sampling a predetermined number of negative labels from a set of negative labels for each of the training data-points; and training the encoder and the classifier vectors using the sampled negative labels; identifying positive labels for each of the training data-points; and computing a loss based on the sampled negative labels and the identified positive labels for the training data-points; and updating encoder parameters and the classifier vectors based on the computed loss. For a first portion of the plurality of training epochs, the sampled negative labels include only uniformly random negative labels. For a second portion of the plurality of training epochs, the sampled negative labels include uniformly random negative labels and hard negative labels. The hard negative labels are identified using an Approximate Nearest Neighbor Search (ANNS) index built on the classifier vectors.

In yet another general aspect, the instant disclosure presents a method of training an extreme classifier model. The method includes receiving a plurality of training data-points and a plurality of classifier vectors associated with the training data-points for an extreme classifier model, the training data-points each corresponding to a query, each of the classifier vectors mapping a different label of a plurality of labels associated with the extreme classifier model to an embedding space; performing a plurality of training epochs, each of the training epochs including: generating query embeddings for each of the training data-points that map the training data-points to the embedding space, the query embeddings being generated using an encoder for the extreme classifier model; sampling a predetermined number of negative labels from a set of negative labels for each of the training data-points; and training the encoder and the classifier vectors using the sampled negative labels; identifying positive labels for each of the training data-points; and computing a loss based on the sampled negative labels and the identified positive labels for the training data-points; and updating encoder parameters and the classifier vectors based on the computed loss. For a first portion of the plurality of training epochs, the sampled negative labels include only uniformly random negative labels. For a second portion of the plurality of training epochs, the sampled negative labels include uniformly random negative labels and hard negative labels. The hard negative labels are identified using an Approximate Nearest Neighbor Search (ANNS) index built on the classifier vectors.

In a further general aspect, the instant application describes a computer readable medium on which are stored instructions that when executed cause a programmable device to perform functions of receiving a plurality of training data-points and a plurality of classifier vectors associated with the training data-points for an extreme classifier model, the training data-points each corresponding to a query, each of the classifier vectors mapping a different label of a plurality of labels associated with the extreme classifier model to an embedding space; performing a plurality of training epochs, each of the training epochs including: generating query embeddings for each of the training data-points that map the training data points to the embedding space, the query embeddings being generated using an encoder for the extreme classifier model; sampling a predetermined number of negative labels from a set of negative labels for each of the training data-points; and training the encoder and the classifier vectors using the sampled uniformly random negative labels; identifying positive labels for each of the training data-points; and computing a loss based on the sampled negative labels and the identified positive labels for the training data points; and updating encoder parameters and the classifier vectors based on the computed loss. For a first portion of the plurality of training epochs, the sampled negative labels include only uniformly random negative labels. For a second portion of the plurality of training epochs, the sampled negative labels include uniformly random negative labels and hard negative labels. The hard negative labels are identified using an Approximate Nearest Neighbor Search (ANNS) index built on the classifier vectors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which aspects of the disclosure may be implemented.

FIG. 2 shows an example implementation of an extreme classification system for the extreme classification service of FIG. 1.

FIG. 3 shows an example implementation of an extreme classifier model for the extreme classification system of FIG. 2.

FIGS. 4A and 4B show graphs of training time versus accuracy (Precision@1) for different negative sampling strategies.

FIG. 5 is a flowchart of an example method of training extreme classifier models using an Approximate Nearest Neighbor Search (ANNS) training strategy according to this disclosure.

FIGS. 6A-6C show graphs of the training times versus accuracy (P@1) for Renée and ASTRA across three datasets, respectively.

FIG. 7A depicts a table that shows the accuracy (Precision@k) and training time in hours for NGAME, Renée, and ASTRA on proprietary datasets with 20 M and 120 M labels.

FIG. 7B depicts a table that shows a comparison of the accuracy (Precision@k) of ASTRA with other state-of-the-art XC methods.

FIG. 7C depicts a table showing the results of an ablative study of different negative mining strategies in ASTRA on three datasets.

FIG. 8 is a block diagram illustrating an example software architecture, various portions of which may be used in conjunction with various hardware architectures herein described.

FIG. 9 is a block diagram illustrating components of an example machine configured to read instructions from a machine-readable medium and perform any of the features described herein.

### DETAILED DESCRIPTION

Classification is a predictive modeling problem that involves outputting a class label given some input. Typically, a classification task involves predicting a single label. Alternately, it might involve predicting the likelihood across two or more class labels. In these cases, the classes are mutually exclusive, meaning the classification task assumes that the input belongs to one class only. Some classification tasks require predicting more than one class label. This means that class labels or class membership are not mutually exclusive. These tasks are referred to as multiple label classification (also referred to as multi-label classification). One typical example of a multi-label classification problem is the classification of documents, where each document can be assigned to more than one class.

Various machine learning algorithms can be used to solve multi-label classification problems. The ML algorithm used depends at least in part on the number of class labels that can be assigned to a particular input instance. Traditional machine learning (ML) classification algorithms, such as one-vs-all, support vector machine (SVM), neural networks, and the like, are capable of solving multi-label classification problems that involve a small number of labels. However, traditional approaches are generally not applicable to multi-label classification problems involving an extremely large number of possible labels.

One of the most successful paradigms for solving multi-label classification problem involving extremely large label sets is referred to as “extreme classifiers” or “extreme classification” (XC). XC employs a deep encoder architecture for embedding query text, and, in some case, labels. A linear one-vs-all style classifier layer is then applied to the embeddings to produce the final predictions for the query. The final predictions are based on scores for each possible query-label pair where the score is a dot product of the query embedding and the classifier (i.e., label) vector. This paradigm is appealing because XC can keep inference costs to a few milliseconds even with hundreds of millions of labels. This is achieved by leveraging approximate nearest neighbor search (ANNS) on the trained classifier vectors to retrieve the top-k relevant labels for a given query.

While the XC algorithms are capable of successfully solving extreme classification problems in an efficient manner, implementing these algorithms can be challenging due to the amount of resources and/or time required for training. The amount of resources and/or time needed for training typically increases as the number of labels increases. As a result, training can become prohibitively expensive to scale (in resources and/or time) as the number of labels increases. Current XC training methods typically involve a trade-off between the computing resources and the amount of time required for training. For example, one approach used to train extreme classifiers is to jointly train encoder parameters and classifiers to achieve state-of-the-art accuracies on standard XC datasets. Training encoder parameters and classifiers in parallel in this manner minimizes the amount of time required for training but maximizes the amount of computing resources (e.g., GPUs) needed for training.

Another approach to training extreme classifiers is through the use of negative mining techniques. Negative mining uses the fact that there are only a few positive labels for each training point, while the rest of the labels which are not positive (referred to as negative labels) can be extremely large. Negative mining methods aim to find per instance negative labels with higher scores, known as hard negatives, and limit the computations of the negative part of the loss to these labels, which can significantly reduce the computational complexity of training. Current negative mining methods typically rely on meticulous strategies, such as periodically clustering all query embeddings, which enables the per-epoch costs to be reduced from a default number of negative labels per query (O(L)) to a smaller number of negative labels per query (O(log L)). While effective in reducing compute resources (e.g., GPUs) associated with training, current negative mining strategies can significantly increase training time because they involve an expensive clustering procedure on all the queries N which can be even larger than L.

To overcome the technical problems and difficulties associated with previously known extreme classification methods, this description provides technical solutions in the form of an XC algorithm, referred to herein as ASTRA, that has accuracy similar to state-of-the-art joint training algorithms, such as Renée, and that keeps per-epoch training costs to O(log L) which enables training to be scaled to extremely large label sets (e.g., 100 million or more). The XC training algorithm according to this disclosure is based on two key observations/design choices: (a) building ANNS index on the classifier vectors and retrieving hard negatives using the classifiers aligns the sampling strategy to the loss function; and (b) keeping the ANNS indices current as the classifiers change through the epochs is prohibitively expensive while using stale negatives results in poor accuracy. These observations have led to the development of a negative sampling strategy that uses a mixture of importance sampling (i.e., hard negatives) and uniform sampling (i.e., random negatives) during each training iteration. This mixed strategy is both efficient and achieves high accuracy. For example, on a proprietary dataset with 120 M labels and 370 M queries, ASTRA achieves Precision@1 of 83.4 in 25 hours on 8 V100s. Renée, a state-of-the-art XC algorithm, achieves 83.8 Precision@1 but takes 375 hours, or 15 times longer than ASTRA, to train on the same hardware. Implementations of other state-of-the-art XC techniques simply do not scale to this size. ASTRA also achieves comparable or better accuracy than state-of-the-art approaches like Renée or DEXA on a number of publicly available datasets with up to 3 M labels while being 2.1-3.6 times faster.

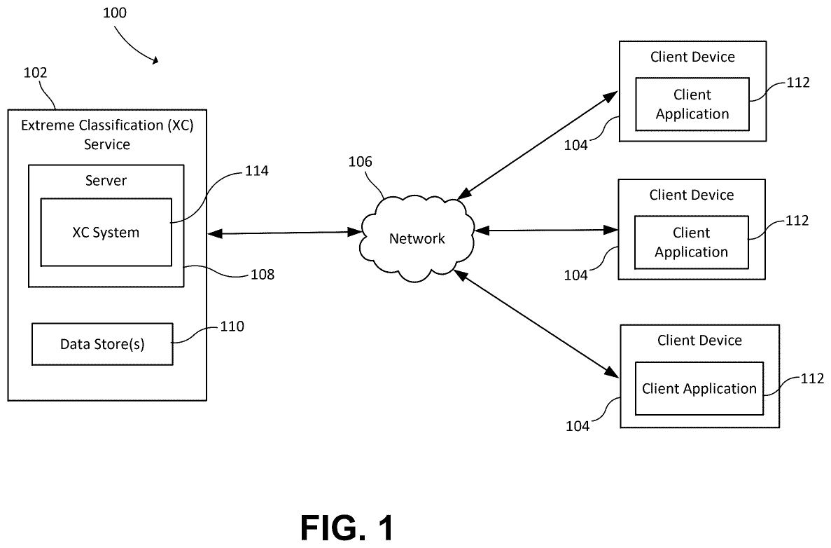

FIG. 1 shows an example computing environment 100 in which aspects of the disclosure may be implemented. The computing environment 100 includes an extreme classification (XC) service 102 and client devices 104 which communicate with each other via a network 106. The network 106 includes one or more wired, wireless, and/or a combination of wired and wireless networks. In some implementations, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network 106 is coupled to or includes portions of a telecommunications network for sending data in a variety of different communication protocols. In some implementations, the network 106 includes Bluetooth® communication networks or a cellular communications network for sending and receiving data including via short messaging service (SMS), multimedia messaging service (MMS), hypertext transfer protocol (HTTP), direct data connection, WAP, email, and the like.

The XC service 102 may be implemented as a cloud-based service or set of services. Examples of extreme classification services which may be implemented by the XC service include recommendation systems, search engines, ad placement services, document categorization, and the like. To this end, the XC service 102 is executed on or includes at least one server 108 which is configured to provide computational and/or storage resources for implementing the XC service 102. The server 108 is representative of any physical or virtual computing system, device, or collection thereof, such as, a web server, rack server, blade server, virtual machine server, or tower server, as well as any other type of computing system used to implement the XC service 102. Servers are implemented using any suitable number and type of physical and/or virtual computing resources (e.g., standalone computing devices, blade servers, virtual machines, etc.). XC service 102 may also include one or more data stores 110 for storing data, programs, and the like for implementing and managing the XC service 102. In FIG. 1, one server 108 and one data store 110 are shown, although any suitable number of servers and/or data stores may be utilized.

Client devices 104 enable users to access the XC service 102 via the network 106. Client devices 104 can be any suitable type of computing device, such as personal computers, desktop computers, laptop computers, smart phones, tablets, gaming consoles, smart televisions and the like. Client devices 104 include at least one client application 112 that is configured to interact with and access the functionality provided by the XC service 102. In various implementations, client application 112 is a dedicated application installed on the client device and programmed to interact with one or more services provided by cloud infrastructure. In some implementations, client application 112 is an add-on, extension, or the like that can be integrated into other applications to enable interaction with the XC service 102. In some cases, client application 112 is a general-purpose application, such as a web browser, configured to access services and/or applications over the network 106.

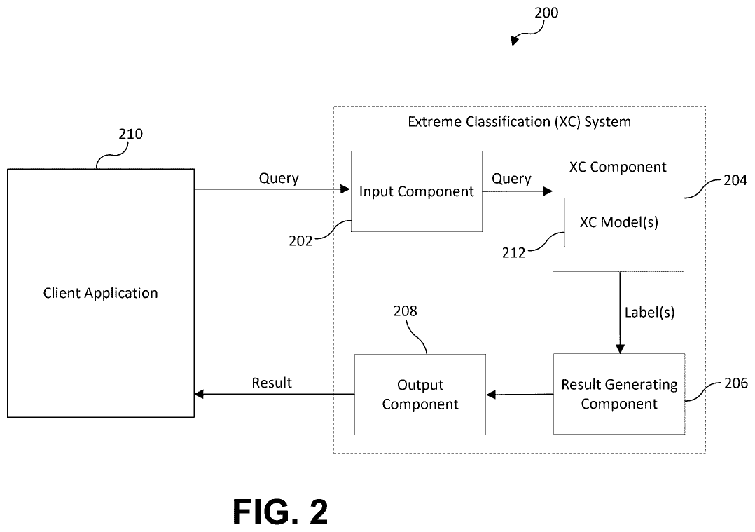

The XC service 102 includes an XC system 114 for implementing the XC service 102. An example implementation of an XC system 200 is shown in FIG. 2. The XC system 200 includes an input component 202, an XC component 204, a result generating component 206, and an output component 208. The input component 202 receives queries from client devices, such as client device 210. The type and format of the query depends on the application for which extreme classification is being used. If the XC service implements a search engine or recommendation service, the query can be in the form of natural language text which includes one or more search terms for the service to use as the basis for generating a response. If the XC service implements a personalized advertising/marketing service, the query may include user information, such as browsing behavior and the like, which can be used by the service to identify advertisements to present to a user.

The input component 202 delivers the queries to the XC component. The input component may be configured to format the query in a manner that facilitates processing of the query in the XC component 204. The XC component 204 includes at least one XC model 212 which is trained to process the queries by identifying the top-k relevant labels for each query. The identified labels can correspond to search results, recommendation results, targeted advertisements, and the like depending on the application. The top-k identified labels are provided to the result generating component 206 which is configured to generate a result based on the top-k identified labels which is appropriate for the corresponding query. The result is then provided to the output component 208 which returns the result to the client device 210 where it can be presented via a user interface.

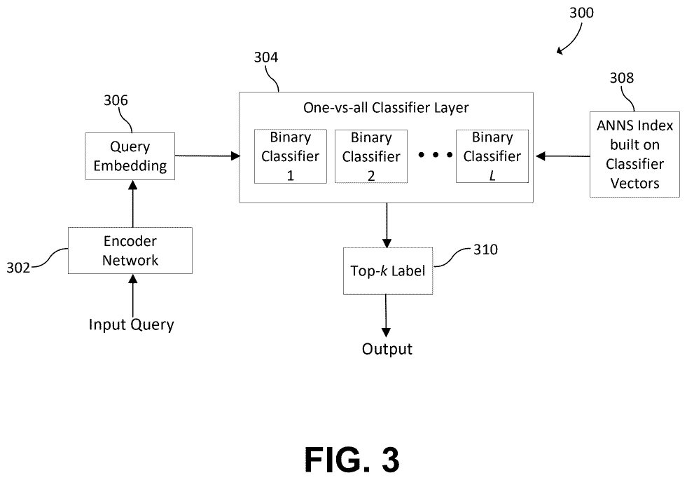

An example implementation of an XC model 300 which may be utilized in an XC system is shown in FIG. 3. The XC model 300 includes two primary components: an encoder network 302 and a classifier layer 304. The encoder network 302 receives input queries and is trained to learn query embeddings 306 for the queries which map query text to a predetermined embedding space. In various implementations, a deep encoder (e.g., DistilBERT) is used to generate the query embeddings for the system although any suitable encoder or encoder architecture may be used. The classifier layer 304 includes or has access to classifier vectors which map all possible classes/labels to the same embedding space used for the query embeddings 306. The classifier layer 304 is trained to generate scores for each label-query pair which are indicative of the probability that the label is associated with the query. Scores may be calculated in any suitable manner. In various implementations, the score for a label corresponds to a dot product of the query embedding and the classifier vector associated with the label. In various implementations, the classifier layer 304 is implemented as one-vs-all classifier. One-vs-all classifiers includes a separate binary classification model associated with each possible class or label for the system. This means that for a dataset with L possible labels, L binary classifiers will be implemented in the classifier layer 304. Each binary classifier is trained to distinguish between a different one of the classes/models and the rest of the classes/models. During prediction, the labels associated with the binary classifiers having the top-k confidence scores are selected as the predicted classes/labels for a given query. The top-k labels 310 are then provided as the output of the classifier layer 304.

The system utilizes Approximate k-Nearest Neighbor Search (ANNS) index 308 built on the classifier vectors to enable fast and efficient retrieval of the top-k relevant labels for a given query. ANNS techniques rely on the generation of an ANNS index for each of the classifier vectors. To generate an ANNS index, classifiers are mapped to an embedding space using a suitable encoder or encoder network which results in a set of classifier vectors. An ANNS index enables fast and efficient searching by reducing the number of candidates that are searched for a given query. The goal of ANNS is to find classifier vectors that are nearest to query embedding without necessarily finding the exact nearest neighbor. For example, to enable fast searching of an ANNS index, the embedding space may be divided into a plurality of zones. During search, the index is scanned and zones that are unlikely to have the nearest neighbors are omitted from the search, and locations with a higher possibility of having nearest neighbors are selected for searching. Using an ANNS search/index is faster than brute force methods, but may be less accurate than brute force methods because, in essence, the index is a lossy representation of the data. Examples of ANN searching/indexing techniques which may be utilized to retrieve top k visual content include hashing-based, tree-based, quantization-based, and graph-based.

As noted above, a key challenge in implementing extreme classifiers is designing training algorithms that are accurate and scalable to extremely large label sets (e.g., 100 million or more). For the purposes of this disclosure. the encoder network is represented by the notation ε_{θ}:x [symbol] ^{d}, and the one-vs-all classifier layer is represented by the notation [symbol] , for [symbol] ∈[L], where [symbol] is a label and [L] is shorthand for the label set {1, 2, . . . , L}, and [symbol] is a classifier vector for label [symbol] . The goal is to learn a prediction model f such that the top-k retrieved labels (based on their scores) are accurate. The prediction model f may be represented by the formula

$${f}_{ℓ} ( x ) = {w}_{ℓ}^{T} {θ}_{} ( x ) .$$

In various implementations, all model parameters are trained end-to-end, which is known to achieve state-of-the-art accuracies on all XC datasets. To this end, a goal is to learn the classifiers [symbol] directly along with the encoder ε_{θ} using a suitable loss on the predicted scores [symbol] (xᵢ) and the ground-truth labels yᵢ. Standard loss functions that may be used are contrastive loss functions, such as the triplet loss or the binary cross entropy (BCE) loss. For the examples described herein, the BCE loss function is used. In various implementations, a stochastic gradient descent (SGD) algorithm is used to compute the loss function. SGD involves updating a set of parameters in an iterative manner to minimize the loss function. SGD utilizes a subset of training samples from a training data set (as opposed to all samples in normal gradient descent) to update a parameter in a particular iteration.

SGD is used to optimize the loss function at each epoch. The per-epoch training time is then dominated by backpropagation, i.e., i.e., computing the gradients of the loss function with respect to encoder parameters and the L classifier weights. For contrastive loss, the per-epoch training time will scale as O(N(L·log L·d+|θ|)), as the number of positive labels per query is typically O(log L). For BCE loss, the per-epoch training time will scale as O(N(Ld+|θ|)), which is only slightly better. In either case, a major bottleneck is the dependency on L (i.e., the number of labels). The reason L factors into the compute complexity is because the default number of negative labels per query is O(L). One goal of training is sampling O(log L) negative labels accurately and efficiently per query to remove the dependence on L. To accomplish this, the instant disclosure presents a negative mining strategy that uses a mixture of importance sampling and uniform sampling.

The negative mining strategy described herein is motivated by two key observations and ideas. The first observation involves aligning the loss with negative sampling. One solution is to directly apply Approximate nearest neighbor Negative Contrastive Estimation (ANCE)-style hard negative sampling for end-to-end training of the XC loss. ANCE-style hard negative sampling involves embedding the labels with label meta-data ε_{θ}( [symbol] ), where [symbol] is the label meta-data, and creating Approximate Nearest Neighbor (ANNS) indices on these embeddings. Hard negatives for a given query can then be sampled from these embeddings. In this case, the XC loss is computed on

$${w}_{ℓ}^{T} {ℰ}_{θ} ( {x}_{i} ) .$$

In this case, the hardest negatives are retrieved using scores based on ε_{θ}( [symbol] )^{T}ε_{θ}(xᵢ). However, this leads to the negative sampling strategy not being aligned with the loss. ANCE-style hard negative sampling techniques for training encoders are used in conjunction with the loss function defined on the scores, i.e., ε_{θ}( [symbol] )^{T}ε_{θ}(xᵢ). Therefore, the correct option for end-to-end XC training is to create ANNS indices on classifier weights [symbol] rather than label embeddings of the encoder. Hard negatives are then retrieved using the classifier weights [symbol] . This approach not only helps in aligning the indices and the negative sampling strategy to the loss function but has the side-benefit that it enables the solution to work on datasets without label features.

The second observation is that training with up-to-date negatives is prohibitively expensive while training with stale negatives results in poor accuracy. The theory of importance sampling that guides optimal selection of mini-batches in SGD (i.e., how to select mini-batches and learning rates to accelerate convergence of SGD) may be used to help derive a scheme to ideally sample negative labels. This theory can be applied to selecting negative labels to estimate the loss function on a small set of negative labels, rather than all negative labels, to accelerate convergence of SGD.

For a given query x the norm of the gradient of the loss function with respect to classifier weights [symbol] , is proportional to the sigmoid of the score

$${f}_{ℓ} ( x ) = {w}_{ℓ}^{T} {θ}_{} ( x ) .$$

The sampling strategy for the query x at a given iteration t is to sample label l proportional to the sigmoid of the score

$${w}_{ℓ}^{{( t )}^{T}} {{θ}^{t}}_{} ( x ) ,$$

where the subscript ^{(t)} denotes the latest iteration of the parameters. This requires re-creating ANNS indices for [symbol] after every update to the parameters, which is very resource intensive.

One approach used to reduce the amount of resources required for negative sampling is to use “stale” indices to do the sampling. For example, at iteration t, negative labels for query x are sampled using the importance sampling distribution that is offset by some (configurable number of) iterations. This entails using the scores

$${w}_{ℓ}^{{( {t}^{′} )}^{T}} {{θ}^{{t}^{′}}}_{} ( x ) ,$$

where t′<t and denotes the last iteration when the indices were refreshed. Note that fresh query embeddings could be used, i.e.,

$${w}_{ℓ}^{{( {t}^{′} )}^{T}} {{θ}^{t}}_{} ( x ) ,$$

but, in general, both query embeddings and classifier weights can be stale. This is particularly true if asynchronous sampling is desired.

To understand the impact of staleness on performance, 1K labels were sampled from small subsets of LF-AmazonTitles-131K and LF-Amazon-131K datasets, and all the queries that cover the 1K labels were retained. A stale approach was used in which ANNS indices were refreshed every 5 epochs against the oracle sampling strategy where the ANNS indices are kept up-to-date by building fresh indices after every iteration. The oracle strategy is computationally expensive even on the 1K sampled dataset and prohibitively expensive on the full 131K dataset. Note that for these datasets, the model size is dominated by the encoder network (over 80 M parameters). The encoder is initialized with pre-trained weights (trained on the full dataset). Classifiers were then initialized randomly. The encoder and classifier parameters were then jointly trained (with tuned learning rates) using mini-batched SGD updates and BCE loss.

To address the shortcomings of up-to-date and stale negative mining strategies, the instant disclosure presents a negative mining strategy that uses a mixture of importance sampling and uniform sampling distributions. Given a query x, let Lₓ denote the positive label set of x. One goal is to design a multinomial distribution over [L]\ₓ negative labels such that (a) it well approximates the aforementioned oracle sampling strategy, and importantly, (b) it allows fast sampling. A relaxed implementation of the oracle importance sampling strategy can be used to help derive the multinomial distribution. In that implementation, a smoothing constant is added to the (stale) probabilities in order to be robust to variations induced by staleness in distributed SGD settings. In testing, it was found that the naïve uniform sampling of negatives is often better than stale negative sampling strategy. Therefore, to counter the impact of staleness, a mixture distribution sampling strategy which involves sampling negative labels for query x at iteration t:

$${P}^{( t )} ( x ) = ( 1 - c ) {P}_{Imp}^{( {t}^{′} )} ( x ) + c {P}_{Unif} ,$$

where t′<t is the last ANNS index update iteration, and c is a hyperparameter that governs the ratio of stale hard negatives and uniformly random negatives. This sampling strategy, referred to herein as ASTRA, enables fast sampling. For example, to sample log N negative labels per query, (1−c) log N most-likely negatives are retrieved based on

$${P}_{Imp}^{( {t}^{′} )}$$

and c log N labels are retrieved uniformly at random from [L]\Lₓ.

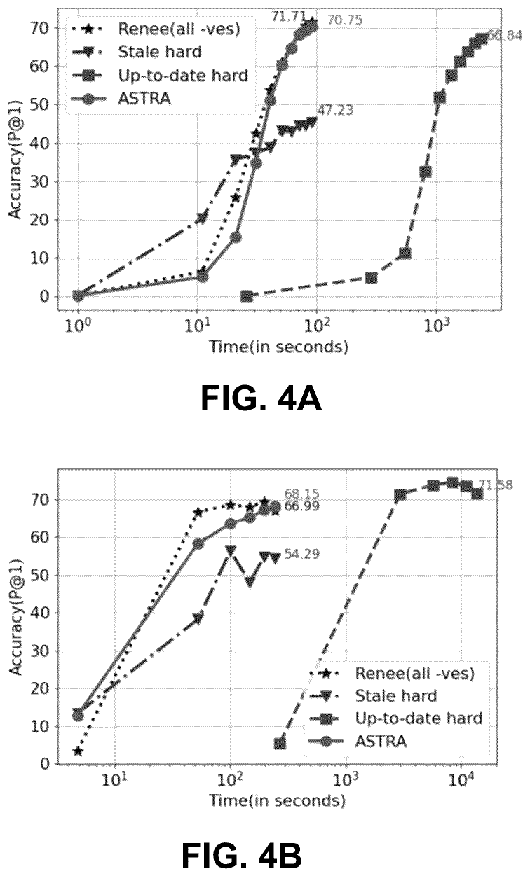

FIGS. 4A and 4B show training time versus accuracy (Precision@1) for different negative sampling strategies including Renée, stale hard negatives, up-to-date hard negatives, and ASTRA. Stale hard negatives use stale classifier weights, while up-to-date hard negatives use an ANNS index on classifier weights every iteration to sample hard negatives. ASTRA uses a mixture of random negatives and stale hard negatives. One epoch is a pass over all queries using minibatches of size 512 and training was performed for 100 epochs in total. In both the cases, instead of sampling, 200 top-scoring negative labels (i.e., hardest negatives) were retrieved from the respective distributions per query. At convergence, it can be seen that the accuracy of the up-to-date strategy is very close to that of the state-of-the-art solution (i.e., Renée) that uses all the negatives, but the up-to-date strategy is orders of magnitude slower than the other methods because of the sheer overhead in keeping the ANNS indices fresh with the parameter changes. On the other hand, it can be seen that the stale strategy performs poorly with regard to accuracy. For example, on the LF-AmazonTitles-1K (FIG. 4A), the converged stale solution (with a Precision@1 of 47.23) is significantly worse than the best (71.71). This observation also holds for LF-Amazon-1K (FIG. 4B) as well as several other XC datasets.

Pseudocode for the ASTRA algorithm (i.e., Algorithm 1) is shown below. For efficiency, the ANNS index is refreshed every τₜ epochs (e.g., 5 epochs) and the same set of negatives are used for the interim τₜ epochs (i.e., the epochs between ANNS index refreshing). To further reduce the overheads, the next set of negatives are retrieved before the refresh period completely lapses. For example, if the ANNS index is to be refreshed in epoch 10, query embeddings can be saved, for example, in epoch 8, and the set of negatives to use in refreshing the ANNS index can be retrieved in epoch 9, so that the ANNS index is ready when epoch 10 starts. The preparation of updated ANNS indices can be performed asynchronously on CPUs while the training epochs are underway on GPUs. Thus, ANNS-based operations do not require any additional GPU compute or memory.

Algorithm 1 ASTRA

Require: Init encoder ε_{θ}(x), classifiers W, mini-batch size S, num hard negatives kₕ, num
random negatives kᵣ, ANNS refresh interval τᵣ, epoch at which to start using hard negatives τₛ

| | |
|---|---|
| 1: | for epoch t = 0, . . . ,T do |
| 2: | Divide all data-points into random mini-batches of size S |
| 3: | for every mini-batch Sₜ do |
| 4: | Embed data-points (queries) using encoder ε_{θ}_{^{(t)}} (•) |
| 5: | if t < τₛ then {Use random negatives to train ε_{θ}(x) and W} |
| 6: | Sample Nᵢ negatives (=kₕ+kᵣ) uniformly at random from the feasible |
| | negative set for each data point i ∈ Sₜ |
| 7: | end if |
| 8: | if t >= τₛ and t%τ = 0 then {Redo ANNS refresh at regular intervals} |
| 9: | Use W^{(t)} to build an ANNS index on. |
| 10: | Get kₕ nearest neighbors for each data-point using ANNS index, to be |
| | used until the next ANNS refresh |
| 11: | end if |
| 12: | if t >= τₛ then {Use hard+random negatives to train ε_{θ}(x) and W} |
| 13: | Get Nᵢ of negatives by sampling kᵣ negatives uniformly at random (Rᵢ) |
| | and kₕ hard negatives (Hᵢ, most recent sample) for each data-point i ∈ |
| | Sₜ |
| 14: | end if |
| 15: | Take positive labels Pᵢand sampled negative labels Nᵢ for each data point i ∈ Sₜ |
| 16: | Compute BCE loss using Pᵢ and Ni as given in equation (2) |
| 17: | Update ε_{θ}_{^{(t)}} (•) using mini-batch Adam over Sₜ and W₍ₜ₎ using mini-batch SGD |
| | over Sₜ |
| 18: | end for |
| 19: | end for |

For analysis purposes, let W denote the d×L matrix of classifier weights, and let ϕₓ=ε_{θ}(x).
For convenience, define

$${ℒ}_{+} ( θ , W ; x ) : = {\sum }_{ℓ = 1}^{L} {y}_{ℓ} log ( 1 + exp ( - {w}_{ℓ}^{T} {ϕ}_{x} ) ) ,$$

$$and$$

$${ℒ}_{-} x ( θ , W ; x , S ) := {\sum }_{ℓ ∈ s} ( 1 - {y}_{ℓ} ) ( {w}_{l}^{T} {ϕ}_{x} + log ( 1 + exp ( - {w}_{ℓ}^{T} {ϕ}_{x} ) ) ) .$$

The (full) loss function that is to be optimized is the average of losses over data-points x given by:

$$ℒ ( θ , W ; x ) := {ℒ}_{+} ( θ , W ; x ) + {ℒ}_{-} ( θ , W ; x , [ L ] ) , \qquad ( 1 )$$

where [L] stands for the set of all labels.

Consider ASTRA at epoch t. Let

$${H}_{i}^{( t )}$$

denote the set of hard negatives for xᵢ sampled in step 10 of the Algorithm 1, and

$${R}_{i}^{( t )}$$

denote the set of random negatives sampled in step 13 of the Algorithm 1. The following lemma shows two properties: (i) the BCE loss estimator in Step 16 of Algorithm 1, and given below in (2) for a data point x, is unbiased, as are its gradients; and (ii) the gradient estimator is strongly concentrated around its expectation.

For ease of understanding, the superscripts W^{(t)} and θ₀^{(t)} can be dropped when it is clear from the context. The loss estimator function at epoch t can written as follows:

$${ℒ}_{A S T R A}^{( t )} ( θ , W ; x ) := {ℒ}_{+} ( θ , W ; x ) + {ℒ}_{-} ( θ , W ; x , {H}^{( t )} ) + \frac{1}{p \cdot {k}_{r}} {ℒ}_{-} ( θ , W ; x , {R}^{( t )} ) , \qquad ( 2 )$$

where p=1/(L−kₕ) is the probability of sampling a label uniformly at random from [L]\H^{(t)}.

Based on the above, a lemma for the lost estimator function (equation 2) is as follows:
Lemma: (1) Loss estimator (equation 2) is unbiased, i.e., E[ [symbol] _{ASTRA}(θ, W; x)]= [symbol] (θ, W; x), and therefore so are the gradients computed in Step 17 of Algorithm 1. (2) For a given ∈>0, δ>0, if

$${k}_{r} = O ( log ( \frac{1}{δ} ) \frac{1}{{ϵ}^{2}} ) ,$$

then with probability at least 1-δ,

$$‖ ∇ {ℒ}_{A S T R A} ( θ , W ; x ) - ∇ ℒ ( θ , W ; x ) ‖ \leq ϵ ‖ ∇ ℒ ( θ , W ; x ) ‖ ,$$

where the norm ∥·∥ above is the vectorized L₂ norm of the gradient.

With these properties of the loss and the gradient estimators in place, a formal convergence result for Algorithm 1 can be given. In particular, the following theorem states that the algorithm converges to a first-order stationary point at the rate of O(1/T), where the hidden (absolute) constants depend on the learning rate and the sub-optimality gap of the initial values for the model parameters.
Theorem: Under certain smoothness assumptions on the loss [symbol] in (1), and under the conditions of kᵣ, ∈; and δ stated in the above Lemma, for a given ∈; if the learning rate is set to

$$η = O ( \frac{1 - ϵ}{1 + {ϵ}^{2}} )$$

in step 17, Algorithm 1, after T iterations, converges to parameters θ, W such that ∥∇ [symbol] (θ, W; x)∥≤O(1/T).

In various implementations, ASTRA can be implemented using a Pytorch framework. For smaller academic datasets, the implementation can be run on a single GPU, but when the number of labels are in a few millions or more, the memory requirements may be beyond the capabilities of a single GPU (e.g., 32 GB V100). Therefore, following the implementation of Renée, ASTRA implementation has a hybrid data- and model-parallel architecture, where encoder is trained in a data-parallel fashion and the classifiers are trained in a model-parallel manner. Consider the scenario with G GPUs, L labels, and B batch size per GPU. In multi-GPU setting, the encoder will produce the embeddings of the input queries in parallel, with each GPU processing BG input queries. An all-gather call is then used to distribute the embeddings to all GPUs to attain the classifiers. The classifiers are divided across GPUs, each GPU processing LG classifiers.

As mentioned in Algorithm 1, ASTRA builds an ANNS index every Tr epochs using classifier weights and gets nearest neighbors for a given query that serve as hard negatives for the query. To reduce the overheads of this process, the ANNS building and the nearest neighbor retrieval process are done in parallel on a separate CPU using stale embeddings and classifier weights while the model is training on the GPU. During the forward pass of every τᵣ−2 epochs, the embeddings of the input queries are saved in a memmap file. The classifier weights of τᵣ−1 epoch is used to build an ANNS index using nearest neighbor algorithms, such as Faiss or DiskANN; and the nearest neighbors are retrieved using stale embeddings so that they serve as hard negatives from epoch τᵣ. For smaller datasets, exact search to retrieve nearest neighbors can be done on the GPUs where the models are trained. However, CPU-based solutions, such as DiskANN, can be used for large datasets with millions of labels. Furthermore, for large datasets, multiple ANNS indices can be built (each on the subsets of labels in each GPU) in parallel using different CPU cores.

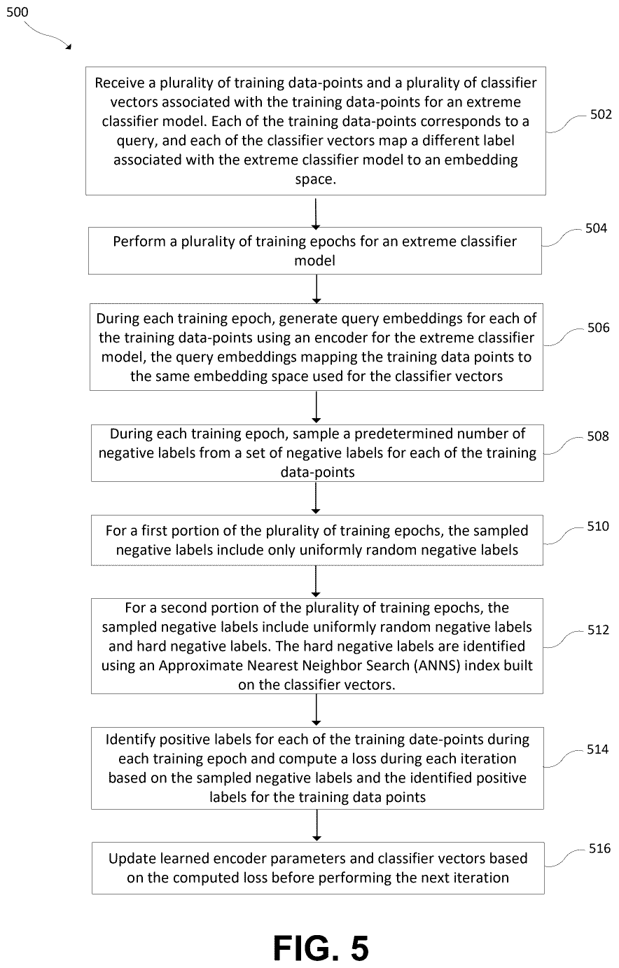

FIG. 5 shows a flowchart of an example method 500 for training extreme classifiers that utilizes the mixed negative sampling strategy according to this disclosure. The method 500 beings with receiving a plurality of training data-points and a plurality of classifier vectors associated with the training data-points for an extreme classifier model (block 502). Each of the training data-points corresponds to a query, and each of the classifier vectors map a different label associated with the extreme classifier model to an embedding space. A plurality of training epochs is performed during (block 504). During each of the training epochs, query embeddings are generated for each of the training data-points using an encoder for the extreme classifier model. The query embeddings map the training data points to the same embedding space used for the classifier vectors (block 506). In addition, a predetermined number of negative labels are sampled from a set of negative labels for each of the training data-points (block 508). For a first portion of the plurality of training epochs, the sampled negative labels include only uniformly random negative labels (block 510). For a second portion of the plurality of training epochs, the sampled negative labels include uniformly random negative labels and hard negative labels. The hard negative labels are identified using an Approximate Nearest Neighbor Search (ANNS) index built on the classifier vectors (block 512). Positive labels are identified for each of the training date-points, and a loss is then computed during each iteration based on the sampled negative labels and the identified positive labels for the training data points (block 514). Learned encoder parameters and classifier vectors are then updated based on the computed loss (block 516).

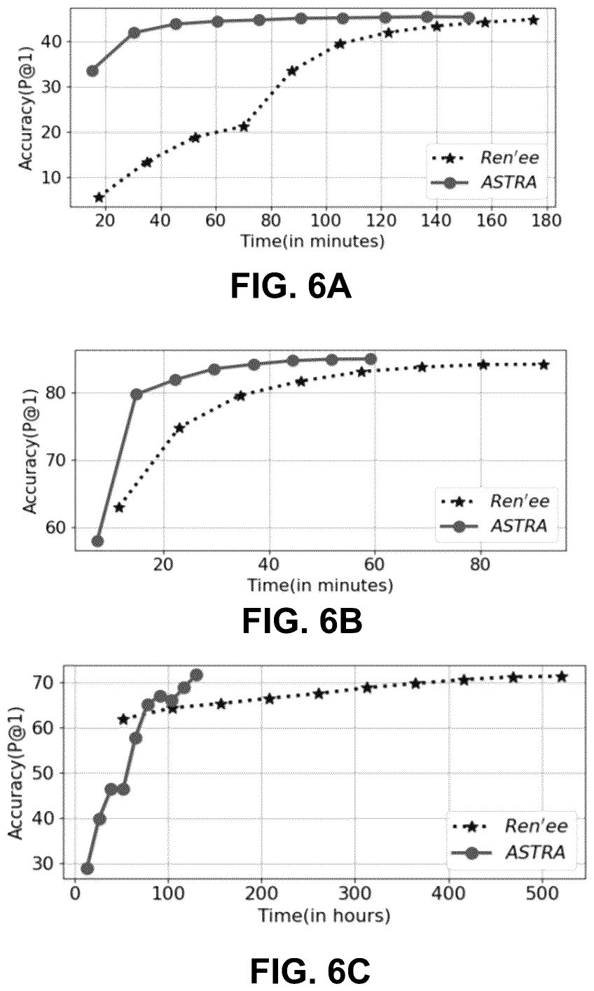

The performance of ASTRA was evaluated in terms of training time as well as precision metrics on proprietary datasets with up to 120 million labels as well as public datasets that have up to 3 million labels. The evaluations also include ablative study that underscores the effectiveness of the proposed negative mining strategy. For the evaluations, multiple short-text and long-text datasets were used with and without label features from an Extreme Classification Repository. These datasets cover a variety of applications including product-to-product recommendation (AmazonTitles-670K, Amazon-670K, AmazonTitles-3 M, Amazon-3 M, LF-Amazon-131K, LF-AmazonTitles-131K, and LF-AmazonTitles-1.3 M) and predicting Wikipedia categories (LF-Wikipedia-500). FIGS. 6A-6C show graphs of the training times vs. accuracy (P@1) for Renée and ASTRA across 3 datasets, respectively. In particular, FIG. 6A shows the training times for LF-AmazonTitles-131K, FIG. 6B shows the training times for LF-Wikipedia-500K, and FIG. 6C shows the training times for SS-20 M. The markers on the lines indicate epoch completion (in multiples of 5). As can be seen, the training time for ASTRA is less than the training time for all three datasets. ASTRA converges much faster as compared to Renée on SS-20 M (FIG. 6C). As mentioned previously, the key advantage in training time comes from the negative sampling which reduces the per-epoch complexity to O(log L) from O(L) of Renée. The ANNS index is built on the CPU and does not require any additional compute time and memory to generate and load alternate label representations such as label embeddings generated from the encoder as done in NGAME.

Evaluations were performed using proprietary datasets with 20 million and 120 million labels, from a sponsored search scenario of matching user queries to advertiser bid phrases. For public datasets with label features, ASTRA was compared with SOTA modular XC methods DEXA, NGAME, and end-to-end methods LightXML, ELIAS, CascadeXML, and Renée. For datasets without label features, ASTRA was compared against AttentionXML, XR-Transformer, LightXML, Renée, CascadeXML, and ELIAS. Prior work includes a combination of results from single models and ensembles. Ensembling is a well-known technique to improve accuracy and can be applied to ASTRA as well. For proprietary datasets, ASTRA was compared against NGAME and Renée which are the only XC methods currently available that are capable of scaling to O(100 M) labels.

ASTRA's hyperparameters are: (i) batch-size, learning rate (ii) for the encoder, (iii) for the classifiers, (iv) dropout, (v) weight decay for classifier, (vi) number of random negatives, (vii) number of hard negatives, (viii) starting epoch for hard negative sampling, (ix) refresh frequency for ANNS index. Adam and SGD optimizers were used for the encoder and classifiers, respectively. The hyperparameters for baseline methods were set as per established guidelines or by fine-grained validation otherwise.

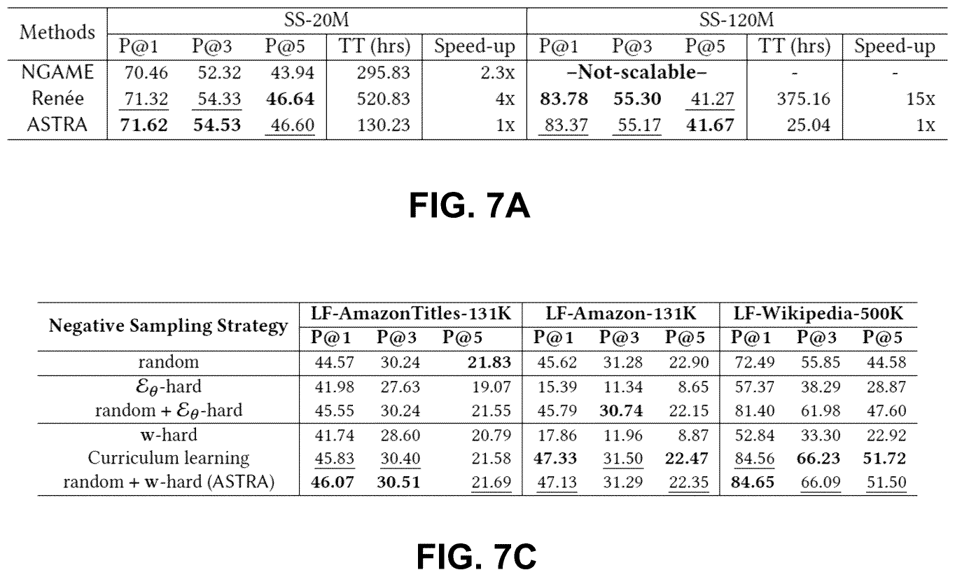

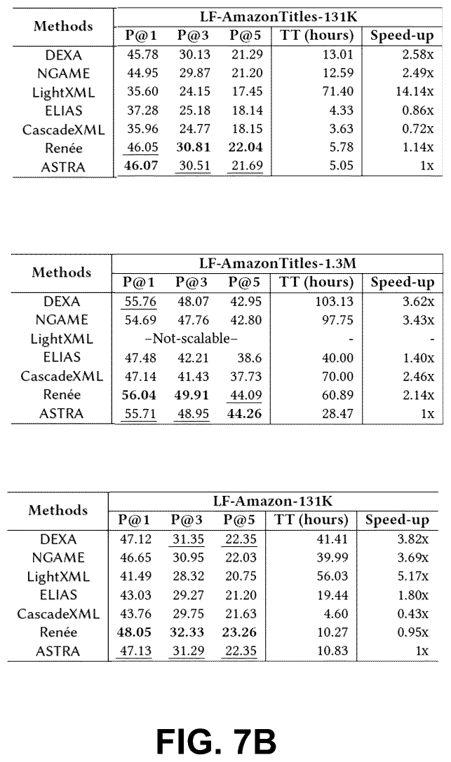

The table depicted in FIG. 7A shows that ASTRA matches the state-of-the-art (Precision@k, k∈1, 3, 5) with 4× and 15× speed-up in the training time for SS-20 M (where all the methods are run on 2 V100 GPUs) and SS-120 M (where all the methods are run on 8 V100 GPUs) datasets respectively. The table shown in FIG. 7B shows how ASTRA compares with the XC baselines and SOTA XC methods on public datasets with label features. As can be seen in the table, ASTRA performs comparable to state-of-the-art on all the datasets in terms of precision metrics. Further, ASTRA achieves up to 3.6× speed-up in training time compared to DEXA and up to 2.14× speed-up compared to Renée on 1 V100 GPU. Note that the precision values reported are of single model and not for ensembles. Similar trends were observed on datasets without label features.

The table depicted in FIG. 7C shows the results of an ablative study of negative mining strategies on three datasets (LF-AmazonTitles-131K, LF-Amazon-131K, and LF-Wikipedia-500K) In all the rows, the total number of negative labels per query is fixed (to 2K). Hard negatives obtained using ANNS indices built on label embeddings (rather than classifier vectors) are denoted as “ε_{θ}-hard.” Hard negatives obtained using ANNS indices built on classifier vectors are denoted as “w-hard”. “Curriculum learning” denotes gradually increasing the ratio of w-hard random negatives through the training epochs. From the table, it can be observed that the proposed strategy of using classifier weights to generate ANNS indices (row 4) outperforms using label embeddings (rows 2 and 3) across all three datasets. The table also shows that using a mixture of stale hard negatives and uniformly random negatives (last row) outperforms the use of stale hard negatives (denoted by w-hard).

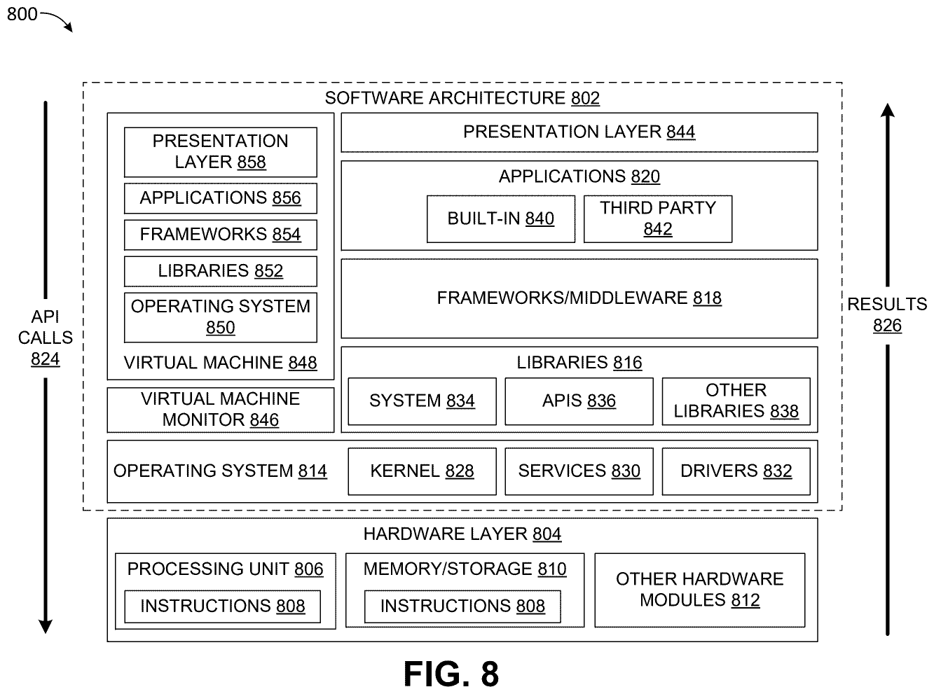

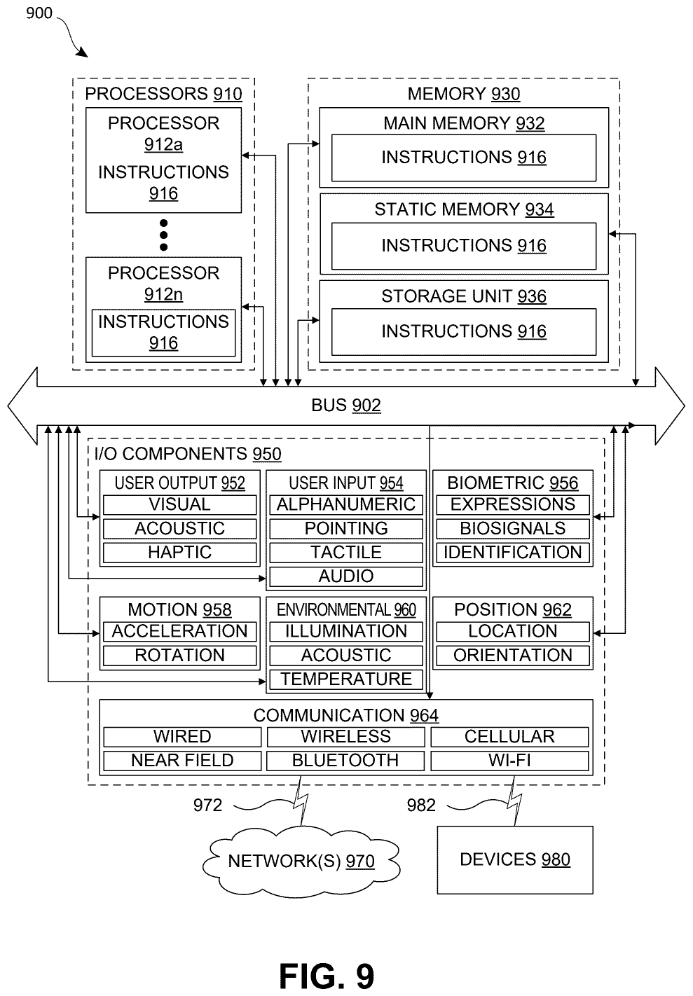

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks 818 (also sometimes referred to as middleware) provide a higher-level common infrastructure that may be used by the applications 820 and/or other software modules. For example, the frameworks 818 may provide various graphic user interface (GUI) functions, high-level resource management, or high-level location services. The frameworks 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multi-core processor including cores that may execute instructions contemporaneously. Although FIG. 9 shows multiple processors, the machine 900 may include a single processor with a single core, a single processor with multiple cores (for example, a multi-core processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a memory storing executable instructions which, when executed by the processor, causes the processor, alone or in combination with other processors, to perform a plurality of functions including:
receiving a plurality of training data-points and a plurality of classifier vectors associated with the training data-points for an extreme classifier model, the training data-points each corresponding to a query, each of the classifier vectors mapping a different label of a plurality of labels associated with the extreme classifier model to an embedding space;
performing a plurality of training epochs, each of the training epochs including:
generating query embeddings for each of the training data-points that map the training data-points to the embedding space, the query embeddings being generated using an encoder for the extreme classifier model;
sampling a predetermined number of negative labels from a set of negative labels for each of the training data-points; and
training the encoder and the classifier vectors using the sampled negative labels;
identifying positive labels for each of the training data-points; and
computing a loss based on the sampled negative labels and the identified positive labels for the training data-points; and
updating encoder parameters and the classifier vectors based on the computed loss,
wherein:
for a first portion of the plurality of training epochs, the sampled negative labels include only uniformly random negative labels,
for a second portion of the plurality of training epochs, the sampled negative labels include uniformly random negative labels and hard negative labels, and
the hard negative labels are identified using an Approximate Nearest Neighbor Search (ANNS) index built on the classifier vectors.

2. The data processing system of claim 1, wherein the ANNS index is refreshed once every predetermined number of epochs.

3. The data processing system of claim 1, wherein the predetermined number of epochs is 5.

4. The data processing system of claim 2, wherein:
the training of the encoder and the classifier vectors is performed using GPUs, and
the ANNS index is generated and refreshed offline using one or more CPUs.

5. The data processing system of claim 1, wherein the encoder comprises a deep encoder.

6. The data processing system of claim 1, wherein per epoch training time is O(log L) where L is a total number of labels used by the extreme classifier model.

7. The data processing system of claim 1, wherein the loss is binary cross entropy (BCE) loss.

8. The data processing system of claim 1, wherein the encoder parameters and the classifier vectors are updated using a stochastic gradient descent algorithm.

9. A method of training an extreme classifier model, the method comprising:
receiving a plurality of training data-points and a plurality of classifier vectors associated with the training data-points for an extreme classifier model, the training data-points each corresponding to a query, each of the classifier vectors mapping a different label of a plurality of labels associated with the extreme classifier model to an embedding space;
performing a plurality of training epochs, each of the training epochs including:
generating query embeddings for each of the training data-points that map the training data-points to the embedding space, the query embeddings being generated using an encoder for the extreme classifier model;
sampling a predetermined number of negative labels from a set of negative labels for each of the training data-points; and
training the encoder and the classifier vectors using the sampled negative labels;
identifying positive labels for each of the training data-points; and
computing a loss based on the sampled negative labels and the identified positive labels for the training data-points; and
updating encoder parameters and the classifier vectors based on the computed loss,
wherein:
for a first portion of the plurality of training epochs, the sampled negative labels include only uniformly random negative labels,
for a second portion of the plurality of training epochs, the sampled negative labels include uniformly random negative labels and hard negative labels, and
the hard negative labels are identified using an Approximate Nearest Neighbor Search (ANNS) index built on the classifier vectors.

10. The method of claim 9, wherein the ANNS index is refreshed once every predetermined number of epochs.

11. The method of claim 9, wherein the predetermined number of epochs is 5.

12. The method of claim 10, wherein:
the training of the encoder and the classifier vectors is performed using GPUs, and
the ANNS index is generated and refreshed offline using one or more CPUs.

13. The method of claim 9, wherein the encoder comprises a deep encoder.

14. The method of claim 9, wherein per epoch training time is O(log L) where L is a total number of labels used by the extreme classifier model.

15. The method of claim 9, wherein the loss is binary cross entropy (BCE) loss.

16. The method of claim 9, wherein the encoder parameters and the classifier vectors are updated using a stochastic gradient descent algorithm.

17. A non-transitory computer readable medium on which are stored instructions that, when executed, cause a programmable device to perform functions of:
receiving a plurality of training data-points and a plurality of classifier vectors associated with the training data-points for an extreme classifier model, the training data-points each corresponding to a query, each of the classifier vectors mapping a different label of a plurality of labels associated with the extreme classifier model to an embedding space;
performing a plurality of training epochs, each of the training epochs including:
generating query embeddings for each of the training data-points that map the training data points to the embedding space, the query embeddings being generated using an encoder for the extreme classifier model;
sampling a predetermined number of negative labels from a set of negative labels for each of the training data-points; and
training the encoder and the classifier vectors using the sampled uniformly random negative labels;
identifying positive labels for each of the training data-points; and
computing a loss based on the sampled negative labels and the identified positive labels for the training data points; and
updating encoder parameters and the classifier vectors based on the computed loss,
wherein:
for a first portion of the plurality of training epochs, the sampled negative labels include only uniformly random negative labels,
for a second portion of the plurality of training epochs, the sampled negative labels include uniformly random negative labels and hard negative labels, and
the hard negative labels are identified using an Approximate Nearest Neighbor Search (ANNS) index built on the classifier vectors.

18. The non-transitory computer readable medium of claim 17, wherein the ANNS index is refreshed once every predetermined number of epochs.

19. The non-transitory computer readable medium of claim 17, wherein:
the training of the encoder and the classifier vectors is performed using GPUs, and
the ANNS index is generated and refreshed offline using one or more CPUs.

20. The non-transitory computer readable medium of claim 17, wherein per epoch training time is O(log L) where L is a total number of labels used by the extreme classifier model.
